(19) United States
(12) Patent Application Publication
(10) Pub. No.: US 2007/0061338 A1
(43) Pub. Date: Mar. 15, 2007

(54) System and method for countering abusive law enforcement and maintaining, managing and distributing information and reports regarding same

(76) Inventor: Scott Nyland, Alpharetta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/448,588

(22) Filed: Jun. 7, 2006

Related U.S. Application Data
(60) Provisional application No. 60/688,526, filed on Jun. 8, 2005.

(51) Int. Cl. G06F 17/30

(52) U.S. Cl. 707/10; 340/988; 340/825.36

(57) ABSTRACT

A system and method for countering abusive law enforcement comprising an Internet website having a variety of reporting options coupled with a system for investigating and minimizing abusive law enforcement acts. The present invention comprises an electronic database for cataloging instances of misconduct by law enforcement officers and agencies, online complaint forms for filing grievances against police misconduct, and hyperlinks to provide information to victims of police misconduct.

Priority based on U.S. Provisional Application, Ser. No. 60/688,526, filed Jun. 8, 2005, and entitled, “SYSTEM AND METHOD FOR COUNTERING ABUSIVE LAW ENFORCEMENT AND MAINTAINING, MANAGING AND DISTRIBUTING INFORMATION AND REPORTS REGARDING SAME”, is claimed.

### TECHNICAL FIELD

The present invention relates generally to business methods and computer systems, and more specifically to an Internet website comprising an electronic database for cataloging instances of misconduct by law enforcement officers and agencies, complaint forms for filing grievances against police misconduct, and hyperlinks to information for assisting victims of police misconduct.

### BACKGROUND OF THE INVENTION

As the United States government passes more laws to fight the war on terrorism, the citizens of the United States are finding that more of their civil rights are being undermined. Newly enacted laws, such as the Patriot Act, grant law enforcement agents broad powers to identify and capture terrorists before they are able to attack.

Unfortunately, more power often leads to more corruption. With the continued erosion of our Constitutional rights, there is an increased risk of abuse by law enforcement officers and agencies. Regrettably, it is not uncommon for police officers to engage in illegal acts of racial discrimination, sexual harassment and/or police brutality.

Furthermore, victims of police misconduct often do not know what they can do to address such problems. Victims of abusive and illegal law enforcement typically do not know what steps to take and what resources are available to aid them.

Currently, incidents of misconduct are typically investigated by internal review boards designated within each respective law enforcement agency. Unfortunately, however, records of such investigations are not readily accessible by private individuals. More importantly, the current system does not provide for any checks and balances, wherein the police are allowed to police themselves.

Therefore, it is readily apparent that there is a need for a system and method for countering abusive law enforcement, wherein a database for cataloging instances of misconduct by law enforcement officers and agencies is accessible to victims of police misconduct, the media, watch-dog agencies, and the public via a plurality of reports. Moreover, there is a need for such a system and method that comprises information for assisting victims of police misconduct and a means for filing grievances against abusive law enforcement.

### BRIEF SUMMARY OF THE INVENTION

Briefly described, in a preferred embodiment, the present invention overcomes the above-mentioned disadvantages and meets the recognized need for such a system by providing a system and method for countering abusive law enforcement.

According to its major aspects and broadly stated, the present invention in its preferred form is a system and method for countering abusive law enforcement comprising an Internet website having an electronic database, online complaint forms and hyperlinks, and a variety of reporting options coupled with a system for investigating and minimizing abusive law enforcement acts. More specifically, an electronic database is provided for cataloging instances of misconduct by law enforcement officers and agencies. Furthermore, online complaint forms are provided for filing grievances against police misconduct. Hyperlinks are also included to provide information to victims of police misconduct.

In addition, investigative sting operations may be conducted, wherein such operations comprise investigative record review, staged events, undercover actors and hidden cameras in an effort to capture incidents of law enforcement misconduct on video camera.

In general, in one aspect, the invention features a system for collecting and reporting abusive conduct of law enforcement, including a central database connected to a network, data entry points for entering complaints related to law enforcement in the central database and hyperlinks for dissemination and reception of data related to the complaints to a plurality of receivers.

In one implementation, said data entry points are websites.

In another implementation, the system further includes means for tracking individuals who are the subject of abuse allegations.

In another implementation, the means for tracking is video surveillance

In another implementation, the means of tracking is global positioning.

In another aspect, the invention features a method for monitoring law enforcement, including collecting instances of law enforcement misconduct, storing said instances of misconduct in a database, providing a website for accessing said database, and providing hyperlinks to webpages to said website.

In one implementation, data is collected via the Freedom of Information Act.

In another implementation, the method further includes electronic complaint forms for filing into said database.

In another implementation, said electronic complaint forms can be accessed by a plurality of receiver sources.

In another implementation, the method further includes cross-referencing a plurality of electronically filed complaints against a specific individual.

In another implementation, the method further includes initiating a sting operation against said individual if a pre-set number of complaints have been attained.

In another implementation, events -associated with said sting operation can be recorded.

In another implementation, said recorded events can be accessible from said website.

In still another implementation, the method further includes a tracker linked to a specific vehicle of an individual who is a subject of an allegation of abuse.

In yet another implementation, the method further includes tracking careers of individuals in the criminal justice industry.

In another implementation, said hyperlinks are to internal webpages.

In another implementation, said hyperlinks are to external webpages.

In another aspect, the invention features a system for collecting and reporting abusive conduct to a receiver, including means for collecting data, means for storing said data and means for conveying at least a portion of said data to the receiver, wherein the receiver could be a person, a group of persons, a government agency, a private agency, another data base or a media source.

Thus, a feature and advantage of the present invention is that it provides a centralized resource for victims of police misconduct that is accessible over the Internet.

Another feature and advantage of the present invention is it enables fast and convenient access to records of misconduct by individual law enforcement officers and/or agencies.

Still another feature and advantage of the present invention is it streamlines the complaint filing process by enabling a victim of police misconduct to file a formal complaint Online.

Yet another feature and advantage of the present invention is it provides useful information to victims of police misconduct.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a schematic diagram of a system according to the preferred embodiment of the present invention;

FIG. 2 is an exemplary database report according to the preferred embodiment of the present invention; and

FIG. 3 is an exemplary database report according to the preferred embodiment of the present invention.

### DETAILED DESCRIPTION OF THE PREFERRED AND SELECTED ALTERNATIVE EMBODIMENTS

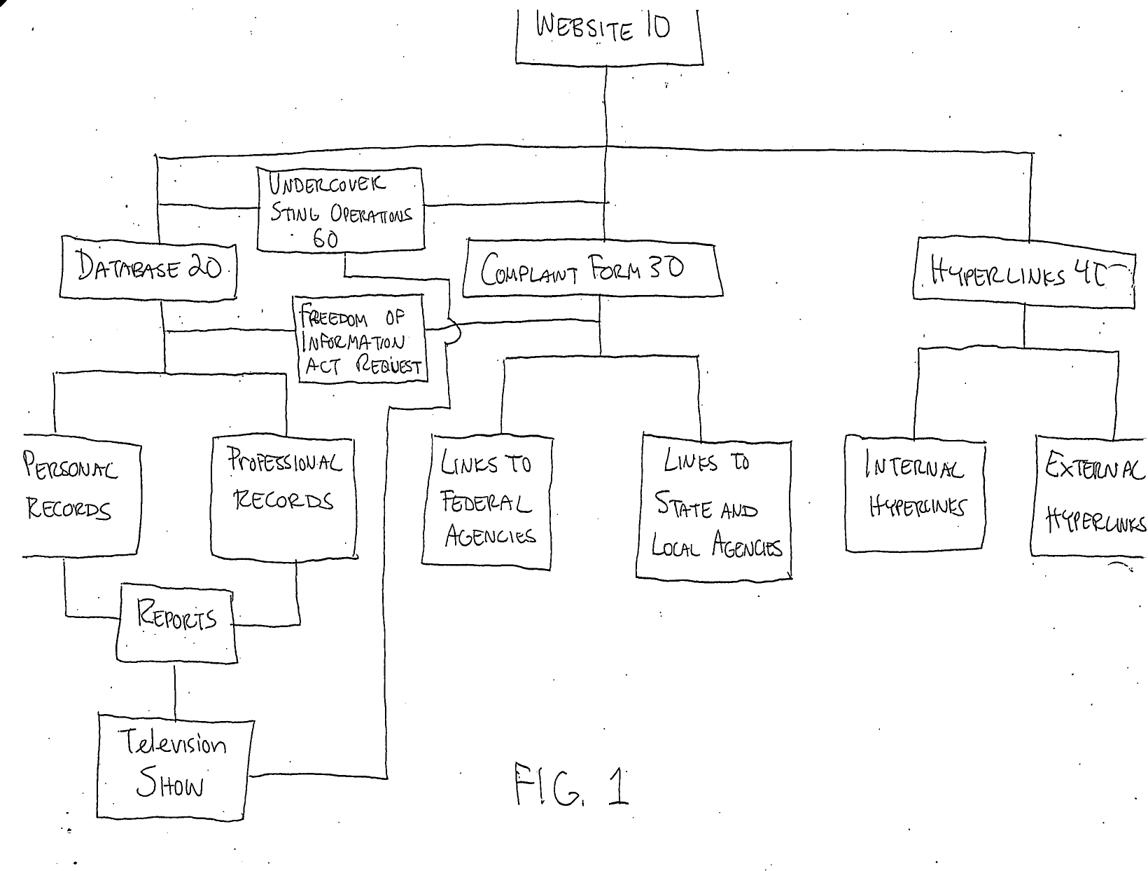

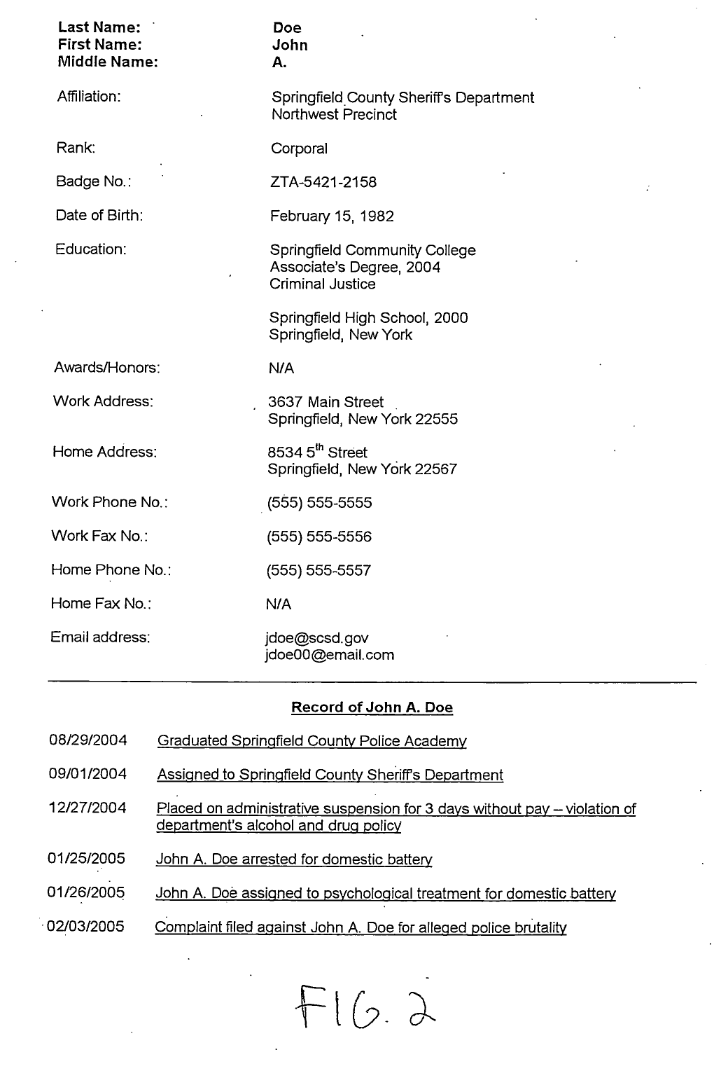

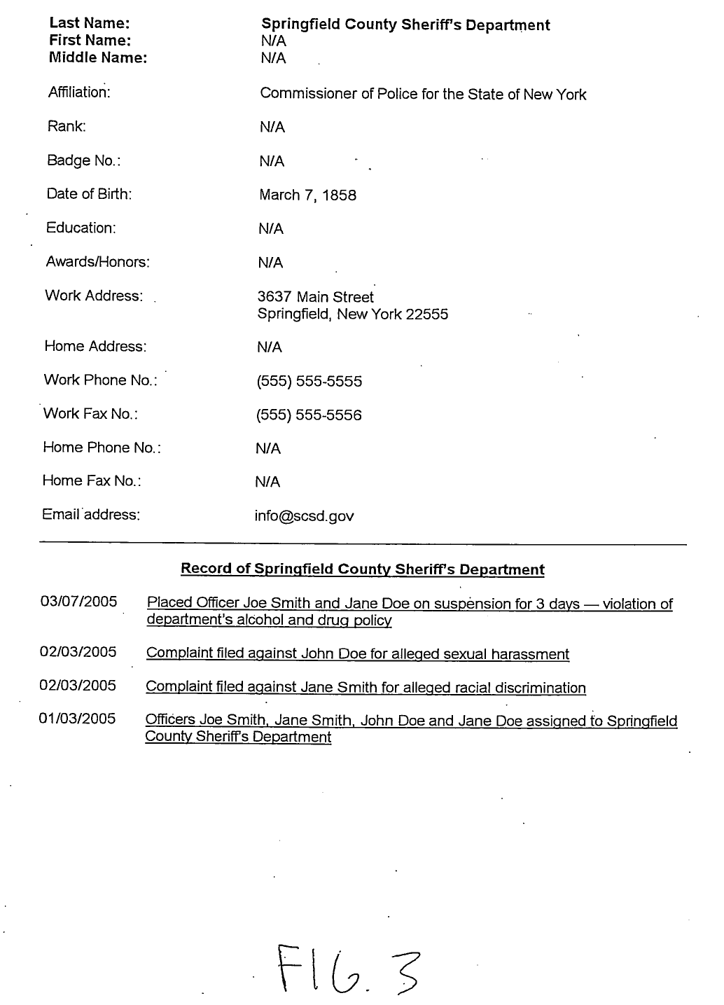

In describing the preferred and selected alternative embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

The present invention in a preferred embodiment is an Internet website 10 for countering, addressing and reducing illegal and abusive enforcement of federal, state and local laws by law enforcement officers and/or agencies. Preferably, website 10 is accessible and suitable for use by a person, a group of persons, a government agency, a private agency, another database, or a media source, wherein website 10 generally comprises database 20, complaint form 30 hyperlinks 40 and undercover sting operations 60.

Database 20 preferably electronically records and catalogues instances of misconduct by law enforcement officers and agencies. Preferably, personal and professional information regarding law enforcement officers and agencies is obtained via the Freedom of Information Act, wherein such information is made accessible on database 20 via a multitude of reports. For non-limiting example, information is preferably collected, stored and may be accessed from database 20 regarding a particular officer/agency's: name; rank; affiliation (e.g., city, county or state police department, FBI, ATF); work address; home address; telephone number(s); fax number(s); email address(es); patrol car license plate number(s) and/or vehicle identification number(s) (VIN); date of birth; education; and experience. Preferably, records of individual events of misconduct are also collected, stored and are accessible from database 20, such as, for exemplary purposes only: filed complaints, including nature and resolution of such complaints; fines, suspensions and/or other disciplinary actions; instances of alcohol and/or drug abuse; instances of aggressive behavior; history of psychological treatment; internal investigations; performance reviews; and civil and/or criminal violations. Although database 20 preferably comprises detailed, comprehensive records of each instance of misconduct, it is contemplated in an alternative embodiment, however, that database 20 could merely provide general information in regards to misconduct. For example, database 20 could merely list the dates and a short description of each complaint filed against Officer John Doe.

Preferably, data stored in database 20 is searchable and sortable. For exemplary purposes only, a user may search database 20 to determine how many complaints of police brutality were filed against the Los Angeles City Police Department in 2004. In another example, a user may search database 20 to determine how many times Officer John Doe was suspended for drug abuse from 1990-1999.

Preferably, complaint form 30 is an electronic means for submitting a complaint against a law enforcement officer and/or agency Online, wherein the complaint may be filed anonymously or non-anonymously. Furthermore, website 10 is preferably linked to the appropriate governmental agencies so that complaints may be processed and responded to in a timely manner. Accordingly, website 10 preferably provides a central location for submitting a complaint and streamlining the complaint through the proper channels. Upon filing of a complaint via complaint form 30, record of such complaint will be preferably subsequently available in database 20.

Preferably, hyperlinks 40 are internal and external links to Internet WebPages, as is commonly known within the art, wherein the Internet WebPages provide information to assist victims of police misconduct. Accordingly, victims of police misconduct may preferably utilize website 10 as a centralized resource to file a complaint against a law enforcement officer and/or agency and to obtain information on how to address, counter and reduce illegal and abusive enforcement of federal, state and local laws.

Sting operations 50 preferably comprise staged events, undercover actors and hidden cameras in an effort to capture incidents of law enforcement misconduct on video camera. Preferably, sting operations 50 could be initiated by application of individuals alleging police misconduct; or sting operations 50 could be initiated after a predetermined number of complaints have been received by database 20 via a Freedom of Information Act request or direct reports of misconduct. Moreover, database 20 is preferably capable of discriminating between different types of complaints, such as, for exemplary purposes only, police brutality, racial discrimination and/or sexual harassment.

For example, a sting operation 50 could be initiated if more than five complaints of racial discrimination are received by database 20 against Officer John Doe. In such an example, undercover actors and hidden cameras are set up, wherein a Caucasian actor intentionally commits a traffic violation in front of a police speed trap monitored by Officer John Doe. The same staged traffic violation is then committed by an African-American actor. At all times, hidden cameras are employed to record any discrepancies in Officer John Doe's treatment toward a Caucasian individual versus an African-American individual.

It is contemplated in an alternative embodiment that electronic audiovisual files showing video footage of sting operations 50 could be downloaded from website 10.

In another alternative embodiment, video footage of sting operations 50 could be displayed on audiovisual media, such as, for exemplary purposes only, DVD or VHS tapes.

In still another alternative embodiment, a television program could be created comprising video footage of sting operations 50 and misconduct complaints.

Although website 10 is preferably a free service that is open to the public, it is contemplated in yet another alternative embodiment that access to website 10 could be restricted to paying members on a flat-fee or hourly basis. Furthermore, varying levels of access to website 10 could be offered, wherein lower membership fees are due for lower levels of access, and wherein greater membership fees are due for higher levels of access.

In still yet another alternative embodiment, complaint form 30 could comprise a form that may be downloaded, filled out electronically, printed, and mailed to the appropriate governmental agency.

In a further alternative embodiment, website 10 could define an offline electronic database that may be accessible via, for example, an Interactive CD-ROM. In such an embodiment, complaint form 30 offers the appropriate complaint forms and the proper addresses in which they should be mailed. Furthermore, hyperlinks 40 include textual and pictographical information to assist victims of police misconduct and Internet URL addresses to more useful information.

In still a further alternative embodiment, website 10 could define a printed hardcopy catalogue, wherein database 20 is organized in alphabetical order by the law enforcement officer/agency's name.

In yet a further alternative embodiment, website 10 could be utilized to counter, address and reduce misconduct by firemen, congressmen, senators, delegates, teachers, priests and other government employees and public officials.

In still yet a further alternative embodiment, website 10 could comprise vehicle tracker 60, wherein vehicle tracker 60 utilizes global positioning satellite (GPS) technology to monitor the exact locations of law enforcement vehicles. In such an embodiment, information relating to vehicles purchased and leased by governmental agencies is obtained via the Freedom of Information Act in an attempt to expose undercover law enforcement officers.

In another alternative embodiment, website 10 could further comprise career tracker 70 for tracking individuals pursing degrees in criminal justice. Accordingly, career tracker 70 monitors and records the career development and/or public records of potential future law enforcement officers for illegal acts, abuse, misconduct and/or the like.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A system for collecting and reporting abusive conduct of law enforcement, comprising:
a central database connected to a network;
data entry points for entering complaints related to law enforcement in the said central database; and
hyperlinks for dissemination and reception of data related to said complaints to a plurality of receivers.

2. The system as claimed in claim 1 wherein said data entry points are websites.

3. The system as claimed in claim 1 further comprising means for tracking individuals who are the subject of abuse allegations.

4. The system as claimed in claim 3 wherein the means for tracking is video surveillance.

5. The system as claimed in claim 3 wherein the means of tracking is global positioning.

6. A method for monitoring law enforcement, comprising:
collecting instances of law enforcement misconduct;
storing said instances of misconduct in a database;
providing a website for accessing said database; and
providing hyperlinks to webpages to said website.

7. The method as claimed in claim 6 wherein data is collected via the Freedom of Information Act.

8. The method as claimed in claim 6 further comprising electronic complaint forms for filing into said database.

9. The method as claimed in claim 8 wherein said electronic complaint forms can be accessed by a plurality of receiver sources.

10. The method as claimed in claim 6 further comprising cross-referencing a plurality of electronically filed complaints against a specific individual.

11. The method as claimed in claim 10, further comprising initiating a sting operation against said individual if a pre-set number of complaints have been attained.

12. The method as claimed in claim 11 wherein events associated with said sting operation can be recorded.

13. The method as claimed in claim 12, wherein said recorded events can be accessible from said website.

14. The method as claimed in claim 6 further comprising a tracker linked to a specific vehicle of an individual who is a subject of an allegation of abuse.

15. The method as claimed in claim 6 further comprising tracking careers of individuals in the criminal justice industry.

16. The method as claimed in claim 6 wherein said hyperlinks are to internal webpages.

17. The method as claimed in claim 6 wherein said hyperlinks are to external webpages.

18. A system for collecting and reporting abusive conduct to a receiver, comprising:
means for collecting data;
means for storing said data; and
means for conveying at least a portion of said data to the receiver, wherein the receiver could be a person, a group of persons, a government agency, a private agency, another data base or a media source.
